(19) United States
(12) Patent Application Publication
(10) Pub. No.: US 2017/0134364 A1
(43) Pub. Date: May 11, 2017

(54) NOTE UPDATE METHOD AND DEVICE

(71) Applicants: LE HOLDINGS (BEIJING) CO., LTD., Beijing (CN); LE SHI ZHI XIN ELECTRONIC TECHNOLOGY (TIANJIN) LIMITED, Beijing (CN)

(72) Inventors: Yuwen CHEN, Beijing (CN); Pu LU, Beijing (CN); Shuangquan ZHOU, Beijing (CN); Xiaofeng LI, Beijing (CN)

(21) Appl. No.: 15/242,418

(22) Filed: Aug. 19, 2016

Related U.S. Application Data
(63) Continuation of application No. PCT/CN2016/084666, filed on Jun. 3, 2016.

(30) Foreign Application Priority Data
Nov. 9, 2015 (CN) 2015107578445

(51) Int. Cl. H04L 29/06; G06F 17/30

(52) U.S. Cl. CPC H04L 63/083; G06F 17/30477; G06F 17/30864

(57) ABSTRACT

Disclosed are a note update method and device. The method includes: a first login terminal receives a first instruction of obtaining a note triggered by a user, the first login terminal sends a request of obtaining a note of the highest version corresponding to an identifier of the first login terminal to a cloud server according to the first instruction, the first login terminal receives the note of the highest version, compares the note of the highest version with a local note, and determines to update the local note or not according to a comparison result. The note of the highest version is a note which is sent by a second login terminal to the cloud server and whose sending time is closest to the current time. The method is used for comparing the obtained note of the highest version with the local note to update the note of the first login terminal, so as to maintain the data consistency of the notes of the first login terminal and the second login terminal and improve the efficiency of the user for querying the note data.

### CROSS-REFERENCE TO RELATED APPLICATIONS

This application is a continuation of International Application No. PCT/CN2016/084666, filed on Jun. 3, 2016, which is based upon and claims priority to Chinese Patent Application No. 2015107578445, filed on Nov. 9, 2015, the entire contents of which are incorporated herein by reference.

### TECHNICAL FIELD

The disclosure relates to the technical field of data update, and in particular, to a note updates method and device.

### BACKGROUND

Notes were gadgets for people to record living tips conveniently, electronic notes bring more imagination space and interestingness for the notes, besides writing characters in the notes, people can also insert pictures and add expressions and the like, and thus the varied demands of the pictures are also increasing. Now, with the popularity of intelligent devices and the mobile Internet, the demands of users for using the electronic notes are increasing, and the usage frequency and the usage amount are larger and larger.

The note generally exists in the form of a client App, the note can also be checked by a user by logging in a Web terminal, in addition, the Web terminal and the client can edit the notes, when the Web terminal or the client singly edits the note, both terminals cannot obtain the note data of the opposite terminal, in the case of a small data size, the note data can be checked by one-to-one comparison, and the consistency of the note data of the Web terminal and the client is maintained, but with the increase of the newly added note data, when the local note is updated or edited, if the local note is not updated or edited on the note data of the opposite terminal, the difference of the note data of the Web terminal and the client is relatively large, when the user wants to query a certain note, but is unclear about the note is edited on which terminal, so the user needs to query the both terminals, thereby reducing the efficiency of the user for querying the note data.

### SUMMARY

The purpose of the present invention is to provide a note update method and device, for improving the efficiency of a user for querying the note data.

According to a first aspect, the present invention provides a note update method, including:

receiving, by a first login terminal, a first instruction of obtaining a note triggered by a user;

sending a request of obtaining a note of the highest version corresponding to an identifier of the first login terminal to a cloud server according to the first instruction, and sending the note of the highest version to the first login terminal;

receiving, by the first login terminal, the note of the highest version, comparing the note of the highest version with a local note, and determining to update the local note or not according to a comparison result; and

wherein, the note of the highest version is a note which is sent by a second login terminal to the cloud server and whose sending time is closest to the current time.

According to a second aspect, the present invention provides an electronic device, including: at least one processors; a memory; and at least one modules stored in the memory, the at least one modules are configured to perform the following operations when being executed by the at least one processors: receiving a first instruction of obtaining a note triggered by a user; sending a request of obtaining a note of the highest version corresponding to an identifier of the first login terminal to a cloud server according to the first instruction, thus allowing the cloud server to check the note of the highest version corresponding to the identifier and send the note of the highest version to the first login terminal; receiving the note of the highest version; comparing the note of the highest version with a local note; determining to update the local note or not according to a comparison result; and wherein, the note of the highest version is a note which is sent by a second login terminal to the cloud server and whose sending time is closest to the current time.

Optionally, the processor is further configured to perform the following steps: updating the local note according to the note of the highest version, when the note of the highest version is not consistent with the local note; displaying the updated local note to the user; or, not updating the local note, when the note of the highest version is not consistent with the local note; and displaying the local note to the user.

Optionally, the processor is further configured to perform the following steps: receiving a second instruction of editing the local note triggered by the user; and sending the edited local note to the cloud server for storage.

Optionally, the processor is further configured to perform the following steps: monitoring whether the local note is in an edition state; storing the current local note in the edition state at an internal of a preset time period and sending the local note in the edition state to the cloud server, when the monitoring module monitors that the local note is in the edition state; and storing the current local note in the edition state and sending the local note in the edition state to the cloud server, when the receiving module receives an instruction of logging out the edition state triggered by the user.

According to a third aspect, the present invention provides a non-volatile computer readable storage medium, where the non-volatile computer readable storage medium stores a computer instruction, and a computer executes the computer instruction to execute the following operations: receiving a first instruction of obtaining a note triggered by a user; sending a request of obtaining a note of the highest version corresponding to an identifier of the first login terminal to a cloud server according to the first instruction, thus allowing the cloud server to check the note of the highest version corresponding to the identifier and send the note of the highest version to the first login terminal; receiving the note of the highest version; comparing the note of the highest version with a local note; determining to update the local note or not according to a comparison result; and wherein, the note of the highest version is a note which is sent by a second login terminal to the cloud server and whose sending time is closest to the current time.

According to the note update method and device provided by the embodiments of the present disclosure, when the user opens a page of the note or triggers an operation of refreshing the page, the first login terminal will obtain the note of the highest version corresponding to the identifier of the first login terminal from the cloud server according to the operation of the user, at this time, the first login terminal compares the note of the highest version with the local note to determine to update the local note or not, and the method is used for comparing the obtained note of the highest version with the local note to update the note of the first login terminal, so as to maintain the data consistency of the notes of the first login terminal and the second login terminal and improve the efficiency of the user for querying the note data.

### BRIEF DESCRIPTION OF THE DRAWINGS

To illustrate technical solutions in the embodiments of the present disclosure or in the prior art more clearly, a brief introduction on the accompanying drawings which are needed in the description of the embodiments or the prior art is given below. Apparently, the accompanying drawings in the description below are merely some of the embodiments of the present disclosure, based on which other drawings may be obtained by those of ordinary skill in the art without any creative effort.

FIG. 1 is a schematic diagram of a flow of a note update method provided by one embodiment of the present disclosure;

FIG. 2 is a schematic diagram of a flow of a note update method provided by another embodiment of the present disclosure;

FIG. 3 is a schematic diagram of a note in a first login terminal provided by one embodiment of the present disclosure;

FIG. 4 is a schematic diagram of a structure of a note update device provided by one embodiment of the present disclosure;

FIG. 5 is a structural block diagram of user equipment provided by one embodiment of the present disclosure.

### DESCRIPTION OF THE EMBODIMENTS

In order that the objectives, technical solutions and advantages of the present disclosure are clearer, a clear and complete description of technical solutions in the embodiments of the present disclosure will be given below, in combination with the accompanying drawings in the embodiments of the present disclosure. Apparently, the embodiments described below are merely a part, but not all, of the embodiments of the present disclosure. All of other embodiments, obtained by those of ordinary skill in the art based on the embodiments of the present disclosure without any creative effort, fall into the protection scope of the present disclosure.

Before the method of the embodiment is illustrated, a first login terminal will be illustrated in detail at first, the first login terminal in the embodiment of the present disclosure can be understood as a client App arranged in a terminal, for example, a mobile terminal, and can also be understood as a Web terminal in a browser, when reading the embodiment of the present disclosure, the first login terminal can be understood as the Web terminal, an opposite terminal of the first login terminal, namely, a second login terminal can be understood as the client App, of course, the method in the embodiment is applicable to the first login terminal and the second login terminal, and no detailed illustration will be given in the embodiment anymore.

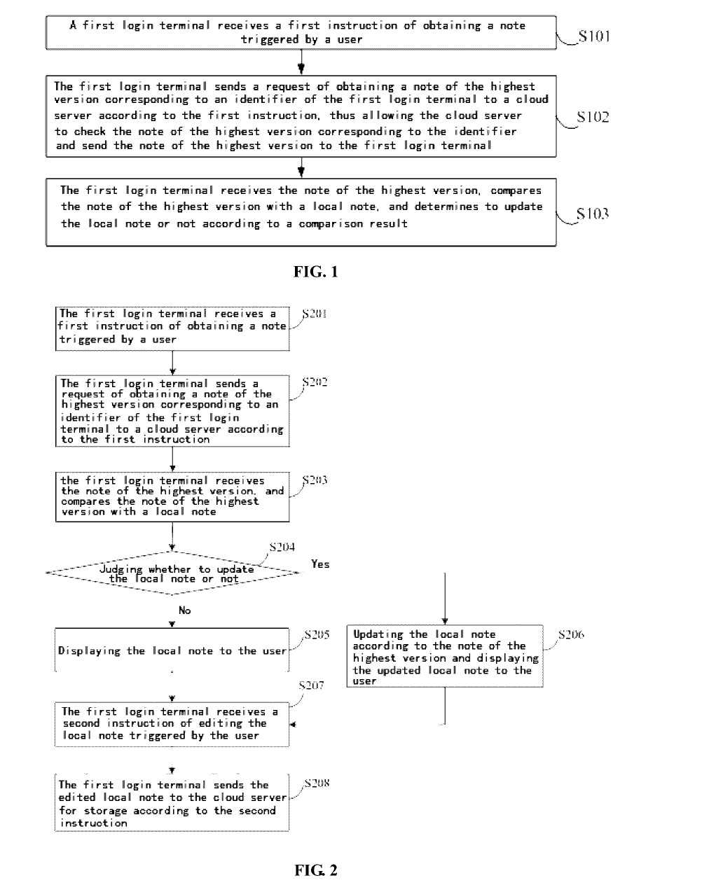

FIG. 1 illustrates a schematic diagram of a flow of a note update method provided by the embodiment of the present disclosure. As shown in FIG. 1, the method includes the following steps:

S101, the first login terminal receives a first instruction of obtaining a note triggered by a user.

In the embodiment, the first login terminal is the Web terminal or the client. In the embodiment, the first login terminal is merely taken as an example for detailed illustration, and of course, the method in the embodiment is also applicable to the second login terminal.

It can be understood that the first login terminal displays the note, before being displayed, the user needs to open the first login terminal by a username and a password and other manners to obtain the note, wherein the first instruction can be understood as being triggered when the user just opens the first login terminal or triggered when the user checks the first login terminal for a long time and clicks a right key through the Web terminal to refresh the page or triggered by a sliding gesture of the user at the client, and this is not limited in the embodiment.

S102, a request of obtaining a note of the highest version corresponding to an identifier of the first login terminal is sent to a cloud server according to the first instruction, thus allowing the cloud server to check the note of the highest version corresponding to the identifier and send the note of the highest version to the first login terminal.

Edited notes of the first login terminal (the Web terminal) and the second login terminal (the client) are stored in the cloud server, wherein when the first login terminal obtains the note from the cloud server, the note of the highest version is a note which is sent by the second login terminal to the cloud server and whose sending time is closest to the current time; and on the contrary, when the second login terminal obtains the note from the cloud server, the note of the highest version is a note which is sent by the first login terminal to the cloud server and whose sending time is closest to the current time.

S103, the first login terminal receives the note of the highest version, compares the note of the highest version with a local note, and determines to update the local note or not according to a comparison result.

The first login terminal is provided with the local note, but the local note in the step S103 can be understood as the local note of the terminal that receives the first instruction of obtaining the note triggered by the user in the step S101. For example, in the step S101, the Web terminal receives the first instruction of obtaining the note triggered by the user, and then, the local note in the step S103 can be understood as the local note of the Web terminal.

In the method, when the user opens a page of the note or triggers an operation of refreshing the page, the first login terminal will obtain the note of the highest version corresponding to the identifier of the first login terminal from the cloud server according to the operation of the user, at this time, the first login terminal compares the note of the highest version with the local note to determine to update the local note or not, and the method is used for comparing the obtained note of the highest version with the local note to update the note of the first login terminal, so as to maintain the data consistency of the notes of the first login terminal and the second login terminal and improve the efficiency of the user for querying the note data.

In the step S103, the determining to update the local note or not according to the comparison result includes the following step that is not shown in FIG. 1:

S1031, when the note of the highest version is not consistent with the local note, the first login terminal updates the local note according to the note of the highest version and displays the updated local note to the user.

In the step S103, the note of the highest version is compared with the local note to maintain the synchronism of the notes of the Web terminal and the client. For example, if the user does not edit the local note on the Web terminal, but edits the local note on the client, at this time, the client will send the edited local note to the cloud server, the cloud server sends the note edited by the client to the Web terminal, and thus the synchronism of the notes of the Web terminal and the client is maintained.

In another implementable mode, the method further includes the following step that is not shown in FIG. 1:

S1032, when the note of the highest version is not consistent with the local note, the first login terminal does not update the local note and displays the local note to the user.

The method will be illustrated below in detail through a specific embodiment.

FIG. 2 illustrates a schematic diagram of a flow of a note update method provided by the embodiment of the present disclosure. As shown in FIG. 2, the method includes the following steps:

S201, the first login terminal receives a first instruction of obtaining a note triggered by a user.

S202, the first login terminal sends a request of obtaining a note of the highest version corresponding to an identifier of the first login terminal to a cloud server according to the first instruction, thus allowing the cloud server to check the note of the highest version corresponding to the identifier and send the note of the highest version to the first login terminal.

S203, the first login terminal receives the note of the highest version, and compares the note of the highest version with a local note.

S204, whether to update the local note or not is determined according to a comparison result, if so, a step S205 is executed, and otherwise, a step S206 is executed.

S205, the local note is not updated, and the local note is displayed to the user.

S206, the local note is updated according to the note of the highest version, and the updated local note is displayed to the user.

After the local note is displayed to the user in the step S205 and the step S206, the method further includes:

S207, the first login terminal receives a second instruction of editing the local note triggered by the user.

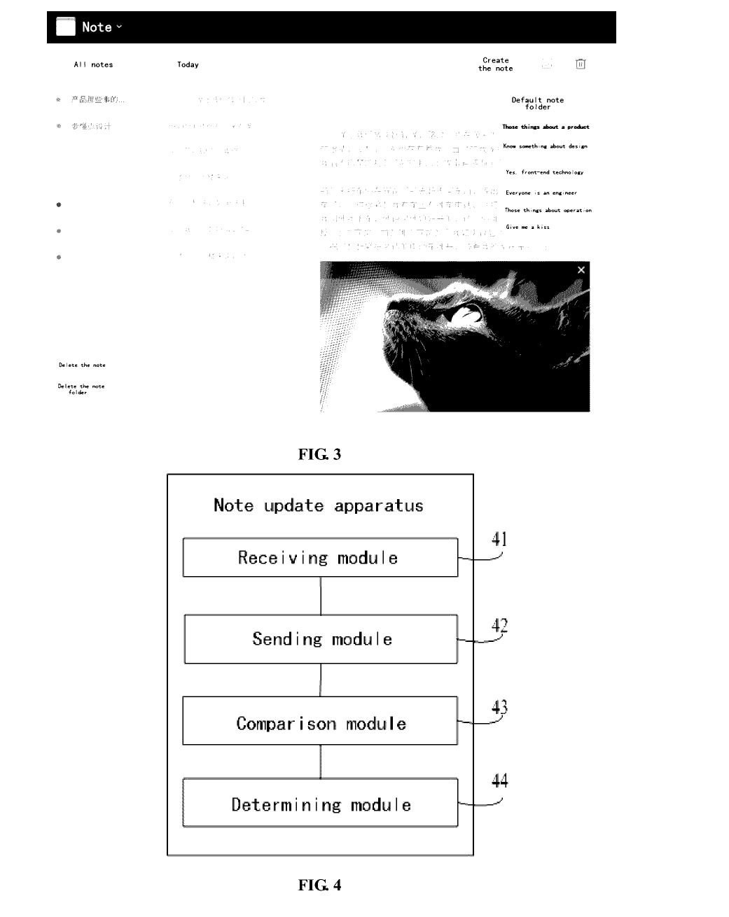

The second instruction can be understood as an operation of the user to the note, as shown in FIG. 3, a note creation operation, a note deletion operation, a note folder creation operation, a note folder deletion operation, transferring a note in a certain note folder into another note folder and the like, and this is not limited in the embodiment.

For example, the user can create a custom note folder, as well as deleting, renaming the same and the like, the note not in any custom group will be stored in a default note folder for the unified management of the user; the user can select and move all notes in a note list into the custom group, the number of the notes in the note folder list changes accordingly to better remind the user of the operation state and greatly improve the efficiency of the user for managing the notes; for a single note, the user can also move the note into the corresponding custom note folder in an edition state; the notes containing pictures in all note contents are marked to be specially displayed, so that the user can find the corresponding note quickly and conveniently.

Further, after the local note is displayed to the user in the step S205 and the step S206, the method further includes:

when receiving a search instruction of the user on the interface for displaying the note to the user, obtaining a keyword corresponding to the search instruction, and matching the search keyword with note names in a preset database;

obtaining a name containing the keyword in the note names, displaying the keyword in the name containing the keyboard in high brightness, and displaying the name to the user; and

wherein, the note names that have been browsed by the user are stored in the preset database.

It can be understood that the first login terminal (the Web terminal) and the second login terminal (the client) further have searching and marking functions, so that the user can quickly look up the keyboard to retrieve a note containing the keyword from all note contents, and the keyword is marked and displayed in high brightness, so the efficiency of the user for operating the target note is further improved.

In the step S207, after receiving the second instruction, the note edited by the user is recorded and stored by the following situation to guarantee the security of the note data edited by the user.

S2071, the first login terminal monitors whether the local note is in an edition state, and if so, a step S2072 is executed; and otherwise, a step S2073 is executed.

S2072, the current local note in the edition state is stored at an interval of a preset time period, and the local note in the edition state is sent to the cloud server; and

the other situation is that, when the note data change, the changed note is directly stored.

The preset time period can be understood as 2 s, 5 s and the like, and this is not limited in the embodiment.

S2073, if receiving an instruction of logging out the edition state triggered by the user, the current local note in the edition state is stored, and the local note in the edition state is sent to the cloud server.

S208, the first login terminal sends the edited local note to the cloud server for storage according to the second instruction.

In the method, the note can include the note folder, the note list and note details, wherein the note folder supports creation, deletion and custom names. All notes and default note folders exist for all the time, and the number of the notes contained in the current note folder is displayed just like the custom note folder; and the note list supports creation, deletion and transfer. The notes containing the pictures and the notes which are not synchronously stored in the cloud are prompted to the user in a marking mode in the list. When the note is transferred, the user drags a mouse into a corresponding note folder; and the content areas of the note details support characters, expression input and picture insertion and the like, the pictures are surrounded by a unified frame and can be dragged subsequently. The note folder can be selected in the note details. The above note includes user data recorded in three times, thereby guaranteeing the security of the user data. The first time is when the contents of the note details change; the second time is to automatically synchronize and store the latest contents every 2 seconds; and the third time is when logging out the edition state.

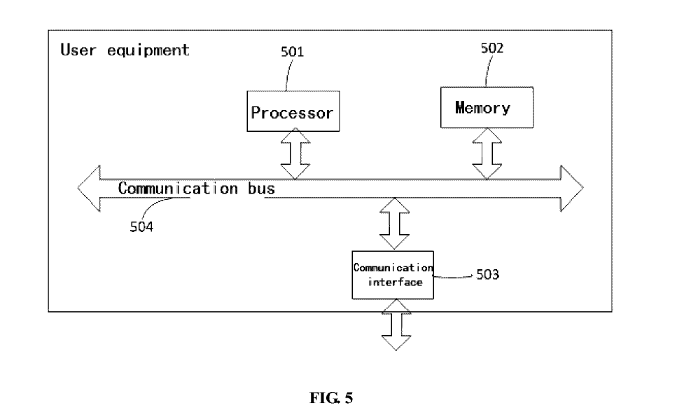

FIG. 4 illustrates a schematic diagram of a structure of a note update device provided by the embodiment of the present disclosure. As shown in FIG. 4, the device includes:

a receiving module 41, used for receiving a first instruction of obtaining a note triggered by a user;

a sending module 42, used for sending a request of obtaining a note of the highest version corresponding to an identifier of the first login terminal to a cloud server according to the first instruction, thus allowing the cloud server to check the note of the highest version corresponding to the identifier and send the note of the highest version to the first login terminal;

the receiving module 41 is further used for receiving the note of the highest version;

a comparison module 43, used for comparing the note of the highest version with a local note;

a determining module 44, used for determining to update the local note or not according to a comparison result; and

wherein, the note of the highest version is a note which is sent by a second login terminal to the cloud server and whose sending time is closest to the current time.

In an optional embodiment of the embodiment, the determining module 44 is further used for updating the local note according to the note of the highest version, when the note of the highest version is not consistent with the local note.

The device further includes the following component that is not shown in FIG. 4:

a display module, used for displaying the updated local note to the user.

In an optional embodiment of the embodiment, the determining module 44 is further used for not updating the local note, when the note of the highest version is not consistent with the local note; and

the display module is used for displaying the local note to the user.

In an optional embodiment of the embodiment, the receiving module 41 is further used for receiving a second instruction of editing the local note triggered by the user; and

the sending module 42 is further used for sending the edited local note to the cloud server for storage.

In an optional embodiment of the embodiment, the device further includes the following component that is not shown in FIG. 4:

a monitoring module, used for monitoring whether the local note is in an edition state;

the sending module 42 is further used for storing the current local note in the edition state at an internal of a preset time period and sending the local note in the edition state to the cloud server, when the monitoring module monitors that the local note is in the edition state; and

the sending module 42 is further used for storing the current local note in the edition state and sending the local note in the edition state to the cloud server, when the receiving module receives an instruction of logging out the edition state triggered by the user.

In an optional embodiment of the embodiment, the device further includes the following components that are not shown in FIG. 2:

an obtaining module used for, when receiving a search instruction of the user on the interface for displaying the note to the user, obtaining a keyword corresponding to the search instruction;

a matching module, used for matching the search keyword with note names in a preset database;

the obtaining module is further used for obtaining a name containing the keyword in the note names, and displaying the keyword in the name containing the keyboard in high brightness;

the display module is further used for displaying the name to the user; and

wherein, the note names that have been browsed by the user are stored in the preset database.

It should be noted that, the device and the method are in one-to-one correspondence, the specific implementation details of the method are also applicable to the device, and thus the specific implementation details of the device will not be illustrated in detail in the embodiment.

The device embodiment described above is merely exemplary, wherein units described as separate components can be separated physically or not, components displayed as units can be physical units or not, namely, can be located in one place, or can also be distributed on a plurality of network units. A part of or all the modules can be selected to achieve the objectives of the technical solutions in the embodiment according to actual demand. Those of ordinary skill in the art can understand and implement the objectives without any creative effort.

By means of the above-mentioned descriptions of the embodiments, those skilled in the art can clearly understand that the embodiments can be implemented by software plus a necessary universal hardware platform, and of course, can be implemented by hardware. Based on this understanding, the technical solutions essentially or the parts contributing to the prior art can be embodied in the form of a software product, the computer software product can be stored in a computer readable storage medium, such as an ROM/RAM, a magnetic disk, an optical disk or the like, and include several instructions for instructing a computer device (can be a personal computer, a server, or a network device and the like) to execute the method in the embodiments or some parts of the embodiments.

FIG. 5 shows a structural block diagram of user equipment provided by another embodiment of the present disclosure.

Refer to FIG. 5, the user equipment includes a processor (processor) 501, a memory (memory) 502, a communication interface (Communications Interface) 503 and a bus 504; wherein,

the processor 501, the memory 502 and the communication interface 503 communicate with each other by the bus 504;

the communication interface 503 is used for completing the information transmission of the smart TV with a router and a second terminal;

the processor 501 is used for invoking a logic instruction in the memory to execute the following method:

receiving a first instruction of obtaining a note triggered by the user;

sending a request of obtaining a note of the highest version corresponding to an identifier of the user equipment to the cloud server according to the first instruction, and sending the note of the highest version to the user equipment;

receiving the note of the highest version, comparing the note of the highest version with a local note, and determining to update the local note or not according to a comparison result; and

wherein, the note of the highest version is a note which is sent by another user equipment to the cloud server and whose sending time is closest to the current time.

FIG. 5 is a schematic diagram of a hardware structure of an electronic device for executing a processing method of list item operations provided by the embodiments of the disclosure. The device includes: one or more processors and a memory, with one processor as an example in FIG. 5.

The device for executing a processing method of list item operations provided by the embodiments of the disclosure may also include: an input device and an output device.

As a non-volatile computer-readable storage medium, the memory is available for storing non-volatile software programs, non-volatile computer-executable programs and modules, such as program instructions/modules corresponding to the processing method of list item operations in the embodiments of the present disclosure. By running non-volatile software programs, instructions and modules stored in the memory, the processor executes various function applications and data processing of a server, i.e., achieving the processing method of list item operations in the above method embodiments.

The memory may include a program storage region and a data storage region, wherein the program storage region is available for storing an operating system, and at least one functionally required application; the data storage region is available for storing data created according to the use of a processing device of list item operations, and the like. In addition, the memory may include a high-speed random access memory, and may also include a non-volatile memory, such as at least one magnetic disk storage device, a flash memory device, or other non-volatile solid-state storage devices. In some embodiments, the memory optionally includes memories remotely set with respect to the processor; these remote memories are connectable to the processing device of list item operations by means of networks. Examples of the networks include, but are not limited to, Internet, Intranet, LAN, mobile communication networks and combinations thereof.

The input device is capable of receiving input digit or character information, and producing key signal inputs related to user settings and function control of the processing device of list item operations. The output device may include a display device such as a display screen.

The one or more modules are stored in the memory, and execute the processing method of list item operations in any above method embodiment when executed by the one or more processors.

The products described above are capable of executing the method provided by the embodiments of the present disclosure, and has corresponding function modules for executing the method and beneficial effects. Those technical details not described in detail in the present embodiment may be found in the method provided by the embodiments of the present disclosure.

The electronic device provided by this embodiment of the present disclosure may be present in a plurality of forms, including but not limited to:
(1) Mobile communication equipment: such equipment is characterized by mobile communication functions and mainly intended to provide voice and data communications. Terminals of this type include: smart phones (e.g., iPhone), multimedia mobile phones, functional mobile phones, low-end mobile phones and so on.
(2) Ultra-mobile personal computer equipment: such equipment falls into the category of personal computers, has computing and processing functions, and generally also has a mobile network access characteristic. Terminals of this type include: PDA, MID, UMPC equipment, and the like, for example iPad.
(3) Portable entertainment equipment: such equipment is able to display and play multimedia contents, and includes: audio and video players (e.g., iPod), handheld game players, electronic book readers, and smart toys and portable vehicle-mounted navigation equipment.
(4) Servers: they are equipment providing computing service. Components of a server include a processor, a hard disk, a memory, a system bus and the like. The architecture of a server is similar to that of a general-purpose computer; however, since servers are required to provide highly reliable services, requirements in such aspects as processing ability, stability, reliability, safety, extendibility and manageability are relatively high.
(5) Other electronic devices having the function of data interaction.

Another embodiment of the present disclosure further discloses a computer program, including a program code, wherein the program code is used for executing the following operations:

receiving a first instruction of obtaining a note triggered by the user;

sending a request of obtaining a note of the highest version corresponding to an identifier of the user equipment to the cloud server according to the first instruction, and sending the note of the highest version to the user equipment;

receiving the note of the highest version, comparing the note of the highest version with a local note, and determining to update the local note or not according to a comparison result; and

wherein, the note of the highest version is a note which is sent by another user equipment to the cloud server and whose sending time is closest to the current time.

The embodiment of the present disclosure provides a non-volatile computer storage medium on which computer-executable instructions available for executing the processing method of list item operations in any method embodiment described above are stored, wherein the storage medium can be a magnetic disk, an optical disk, a read-only memory (ROM), a random access memory (RAM) or the like.

The device embodiments described above are merely schematic, in which units described as separate parts may be or may be not physically separated from one another, and parts displayed as units may be or may be not physical units, i.e., may be located at one place or distributed to a plurality of network units. Part or all of the modules therein may be selected according to actual requirements to achieve the objectives of the solutions in the present embodiment.

According to the above description of the embodiments, a person skilled in the art can clearly understand that various embodiments may be implemented by means of software in combination with a necessary general-purpose hardware platform, and of course, may also be implemented by means of hardware. Based on such understanding, the above technical solutions substantially or the parts making a contribution to the prior art may be embodied in the form of a software product, which can be stored in a computer-readable storage medium, such as an ROM/RAM, a magnetic disk, an optical disk or the like, and which includes a plurality of instructions for causing a computer device (which can be a personal computer, a server, a network device or the like) to execute various embodiments or the method described in some parts of the embodiments.

Finally, it should be noted that the above-mentioned embodiments are merely used for illustrating the technical solutions of the embodiments of the present disclosure, rather than limiting them; although the embodiments of the present disclosure have been described in detail with reference to the foregoing embodiments, those of ordinary skill in the art should understand that they could still make modifications to the technical solutions recorded in the foregoing embodiments or make equivalent substitutions to a part of or all technical features therein; and these modifications or substitutions do not make the essence of the corresponding technical solutions depart from the scope of the technical solutions of the embodiments of the present disclosure.

What is claimed is:

1. A note update method, performing the method at an electronic device, comprising:
receiving, by a first login terminal, a first instruction of obtaining a note triggered by a user;
sending, by the first login terminal, a request of obtaining a note of the highest version corresponding to an identifier of the first login terminal to a cloud server according to the first instruction, thus allowing the cloud server to check the note of the highest version corresponding to the identifier and send the note of the highest version to the first login terminal;
receiving, by the first login terminal, the note of the highest version, comparing the note of the highest version with a local note, and determining to update the local note or not according to a comparison result; and
wherein, the note of the highest version is a note which is sent by a second login terminal to the cloud server and whose sending time is closest to the current time.

2. The method of claim 1, wherein the determining to update the local note or not according to a comparison result comprises:
updating, by the first login terminal, the local note according to the note of the highest version when the note of the highest version is not consistent with the local note, and displaying the updated local note to the user;
or,
not updating, by the first login terminal, the local note, when the note of the highest version is not consistent with the local note, and displaying the local note to the user.

3. The method of claim 2, wherein after displaying the local note to the user, the method further comprises:
receiving, by the first login terminal, a second instruction of editing the local note triggered by the user; and
sending, by the first login terminal, the edited local note to the cloud server for storage according to the second instruction.

4. The method of claim 3, wherein after the first login terminal receives the second instruction, the method further comprises:
monitoring, by the first login terminal, whether the local note is in an edition state;
if so, storing the current local note in the edition state at an interval of a preset time period, and sending the local note in the edition state to the cloud server;
or,
when receiving an instruction of logging out the edition state triggered by the user, storing the current local note in the edition state and sending the local note in the edition state to the cloud server.

5. The method of claim 2, wherein after displaying the local note to the user, the method further comprises:
when receiving a search instruction of the user on the interface for displaying the note to the user, obtaining a keyword corresponding to the search instruction, and matching the search keyword with note names in a preset database;
obtaining a name containing the keyword in the note names, displaying the keyword in the name containing the keyboard in high brightness, and displaying the name to the user; and
wherein, the note names that have been browsed by the user are stored in the preset database.

6. The method of any one of claim 1, wherein the first login terminal is a Web terminal or a client.

7. An electronic device, comprising:
at least one processor; and
a memory communicably connected with the at least one processor for storing instructions executable by the at least one processor, wherein execution of the instructions by the at least one processor causes the at least one processor to:
receive a first instruction of obtaining a note triggered by a user;
send a request of obtaining a note of the highest version corresponding to an identifier of the first login terminal to a cloud server according to the first instruction, thus allowing the cloud server to check the note of the highest version corresponding to the identifier and send the note of the highest version to the first login terminal;
receive the note of the highest version;
compare the note of the highest version with a local note;
determine to update the local note or not according to a comparison result; and
wherein, the note of the highest version is a note which is sent by a second login terminal to the cloud server and whose sending time is closest to the current time.

8. The device of claim 7, wherein the processor is further configured to perform the following steps:
updating the local note according to the note of the highest version, when the note of the highest version is not consistent with the local note;
displaying the updated local note to the user;
or,
not updating the local note, when the note of the highest version is not consistent with the local note; and
displaying the local note to the user.

9. The device of claim 8, wherein the processor is further configured to perform the following steps:
receiving a second instruction of editing the local note triggered by the user; and
sending the edited local note to the cloud server for storage.

10. The device of claim 9, the processor is further configured to perform the following steps:
monitoring whether the local note is in an edition state;
storing the current local note in the edition state at an internal of a preset time period and sending the local note in the edition state to the cloud server, when the monitoring module monitors that the local note is in the edition state; and
storing the current local note in the edition state and sending the local note in the edition state to the cloud server, when the receiving module receives an instruction of logging out the edition state triggered by the user.

11. A non-transitory computer-readable storage medium storing executable instructions that, when executed by an electronic device with a touch-sensitive display, cause the electronic device to:
receive a first instruction of obtaining a note triggered by the user;
send a request of obtaining a note of the highest version corresponding to an identifier of the user equipment to the cloud server according to the first instruction, and sending the note of the highest version to the user equipment;
receive the note of the highest version, comparing the note of the highest version with a local note, and determining to update the local note or not according to a comparison result; and
wherein, the note of the highest version is a note which is sent by another user equipment to the cloud server and whose sending time is closest to the current time.

12. The non-transitory computer-readable storage medium of claim 11, wherein the electronic device is further configured to perform the following steps:
updating the local note according to the note of the highest version, when the note of the highest version is not consistent with the local note;
displaying the updated local note to the user;
or,
not updating the local note, when the note of the highest version is not consistent with the local note; and
displaying the local note to the user.

13. The non-transitory computer-readable storage medium of claim 12, wherein the electronic device is further configured to perform the following steps:
receiving a second instruction of editing the local note triggered by the user; and
sending the edited local note to the cloud server for storage.

14. The non-transitory computer-readable storage medium of claim 13, the electronic device is further configured to perform the following steps:
further comprising:
monitoring whether the local note is in an edition state;
storing the current local note in the edition state at an internal of a preset time period and sending the local note in the edition state to the cloud server, when the monitoring module monitors that the local note is in the edition state; and
storing the current local note in the edition state and sending the local note in the edition state to the cloud server, when the receiving module receives an instruction of logging out the edition state triggered by the user.
